(19) United States
(12) Patent Application Publication
(10) Pub. No.: US 2023/0094166 A1
(43) Pub. Date: Mar. 30, 2023

(54) Device and Method for Verifying Wagers Performed by User Apparatus

(71) Applicant: DILIUM S.R.L., Milano (IT)

(72) Inventors: Paolo Ceravolo, Crema (IT); Donato Angelo De Ieso, Fombio (IT)

(21) Appl. No.: 17/792,104

(22) PCT Filed: Jan. 13, 2021
(86) PCT No.: PCT/IB2021/050205

§ 371 Date: Jul. 11, 2022

(30) Foreign Application Priority Data
Jan. 13, 2020 (IT) 102020000000430

(51) Int. Cl. G06Q 30/018; G06Q 50/34; G07F 17/32

(52) U.S. Cl. CPC G06Q 30/018; G06Q 50/34; G07F 17/3241; G07F 17/329

(57) ABSTRACT

A method and a device for verifying at least one wager in a lottery, and a method and of a user apparatus for performing a wager with the device, are provided where the user apparatus includes a communication component adapted to communicate with the device, an input component adapted to acquire an identification datum that identifies the at least one wager and one image depicting at least one portion of a product or of a package of the product, and a processing component configured to generate product data on the basis of the at least one image, and to transmit, through the communication component, the identification datum and the product data to the device.

### BACKGROUND OF THE INVENTION

### 1. The Field of the Invention

The present invention relates to a method and a device for verifying at least one wager in a lottery, and to a method and a user apparatus for performing a wager with said device; in particular, the present invention verifies wagers relating to an instant electronic lottery, i.e., a lottery in which each player can participate using his own user apparatus (such as for example a smartphone, a tablet or other) and immediately know, after making the wager, whether or not he has won.

### 2. The Relevant Technology

As is known, systems for instant lottery management, which exploit the wide spread of personal electronic devices (such as smartphones, tablets or others), allow a large number of players to be attracted. Some of them are based on augmented reality.

In the American Patent Publication No. U.S. Pat. No. 10,431,049 B2 in the name OF SCIENTIFIC GAMES INTERNATIONAL Inc., the augmented reality allows the activation of an animation in connection with a predetermined physical environment. The activation of the animation and the identification of the wager and the relative award is made through the traditional purchase of a ticket. The ticket identification code can be used to activate an animation that can increase predetermined physical environments, for example some areas of a shopping centre. Communication with a server ensures the verification of the activation code and the definition of the outcome of the wager, with possible award.

In the American Patent Publication No. U.S. Pat. No. 10,424,167 B2 in the name OF SCIENTIFIC GAMES INTERNATIONAL Inc., augmented reality supports the user of a games room in identifying game machines and in understanding the game mechanisms, options and winning opportunities.

As these lotteries can attract many players, they lend themselves well to redistributing high-value awards.

But the increase in the value of the awards increases the risk that the system that manages an instant lottery will become the target of cyber attacks, such as brute force attacks adapted to generate a large number of wagers, so that at least one winning is found.

Moreover, the presence of pre-printed codes on tickets or on product packages (such as, for example, one-dimensional, two-dimensional, hologram or other bar codes) increases the risk of cyber attack, since one or more codes are available to an attacker, if any, and which in the case of pre-printed codes on the product packages, can be acquired in a relatively simple and economical way; in fact, by pretending to make purchases in a shopping centre it is possible to acquire, through a suitably configured smartphone, a large number of codes present on the products on display in a very rapid way. These codes can then be used subsequently to automatically perform a large number of wagers that make it very likely that the attacker will perform at least one winning wager.

### SUMMARY OF THE INVENTION

The present invention aims to solve these and other problems by providing a method and a device for verifying at least one wager in a lottery.

Moreover, the present invention aims to solve these and other problems by also providing a method and a user apparatus for performing a wager with the device according to the invention.

The basic idea of the present invention is to verify a wager (and possibly also determine the outcome thereof) on the basis, in addition to a wager identifier (such as for example an integer), also of product data which allow to identify a specific product (for example, at the level of a single piece or type) and which can be generated on the basis of at least one image depicting at least one portion of a product or of a package of said product. An example of product data may be a binary representation encoding at least one portion of the image, preferably the portion depicting the product or its package, in particular the portion of the package in which a distinctive sign is present, such as for example a product trademark or other. This allows further verifications to be made on the wager, for example it allows to verify that the product or its package is actually on the market (for example by recognizing the expiry date or graphic details inserted specifically on the package) and that the wager was not generated in a malicious way using photographs of products that have already been sold for a long time.

This reduces the likelihood for a cyber attack on the instant lottery (such as a brute force attack) to be successful. In other words, the level of security of said instant lottery is increased.

A further aspect of the invention is the use of augmented reality to allow a further increase in the level of security of the instant lottery. In fact, the use of augmented reality, in addition to having an attractive effect for the customer, allows the user apparatus (for example a smartphone) to be used so that said user apparatus acquires further data (such as for example position data or data associated with the environment surrounding the product depicted in the acquired image), so that further controls of the performed wagers are possible. In greater detail, it is possible to have the user apparatus acquire a second image which depicts an environment surrounding the product or the package of said product, and generate environmental data that describe the environment (such as for example the shelf on which the product is placed, the surrounding area or other) on the basis of said at least one second image. This allows to perform further controls on the wager, reducing the likelihood for a cyber attack to be successful.

A further aspect of the invention is to verify a wager (and possibly also to determine the outcome thereof) on the basis, in addition to a wager identifier (such as for example an integer), also of position data (for example acquired by means of a GNSS receiver of a user apparatus) which describe a position in which said at least one wager has been made. This allows to verify whether the wager has been performed in a position in which the wager identifier is accessible to a user, for example at the point in which said identifier is affixed, in the betting shop or shopping centre where a coupon on which the identifier is written has been delivered or otherwise.

The combination of augmented reality and position data is particularly advantageous, since it allows the user apparatus to be kept in a stationary position and away from the user's body, so as to obtain high quality position data. In this way, it is possible to perform controls on wagers with a higher spatial resolution, thus reducing the likelihood for a cyber attack on the instant lottery (such as a brute force attack) to be successful.

Further advantageous characteristics of the present invention are the subject matter of the appended claims.

### BRIEF DESCRIPTION OF THE DRAWINGS

These characteristics and further advantages of the present invention will become clearer from the description of an embodiment thereof, shown in the accompanying drawings, provided purely by way of non-limiting example, in which:

FIG. 1 illustrates a block diagram of a device for verifying at least one wager in a lottery according to the invention;

FIG. 2 illustrates a system for verifying wagers in a lottery, where said system comprises the device of FIG. 1 and a user apparatus according to the invention;

FIG. 3 illustrates a view of the user apparatus of FIG. 2 in an operating condition;

FIG. 4 illustrates a flow chart representing a method for verifying at least one wager in a lottery according to the invention;

FIG. 5 illustrates a flow chart representing a method for performing at least one wager in a lottery with the device of FIGS. 1 and 2 according to the invention.

### DETAILED DESCRIPTION OF THE PREFERRED EMBODIMENTS

Reference to “one embodiment” within this specification indicates that a particular configuration, structure or feature is included in at least one embodiment of the invention. Therefore the terms “in an embodiment” and the like, used in different parts within this description, do not necessarily all refer to the same embodiment. Furthermore, the particular configurations, structures or features may be combined in any suitable manner in one or more embodiments. The references used below are only for convenience purposes and do not limit the area or scope of protection of the embodiments.

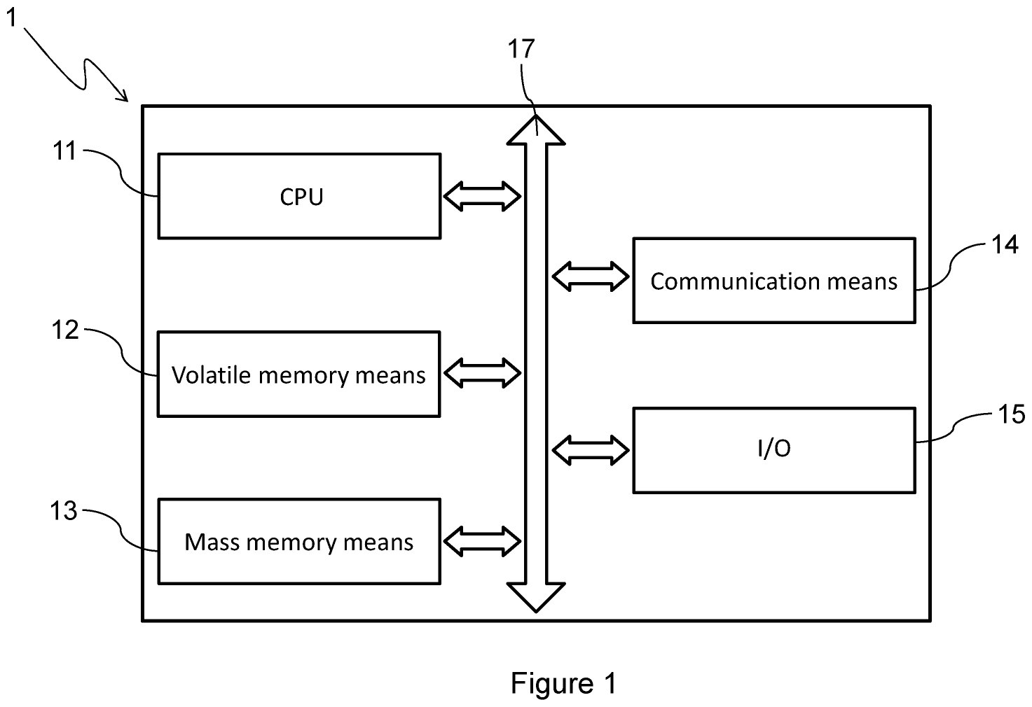

With reference to FIG. 1, an embodiment of a device 1 (such as for example a server, a server cluster, a PC or other) according to the invention comprises the following components:
a control and processing means 11, such as for example one or more CPUs, which controls the operation of the device 1, preferably in a programmable manner, by executing appropriate instructions;
a volatile memory means 12, such as for example a random access memory RAM, which is in signal communication with the control and processing means 11, and wherein said volatile memory means 12 stores at least the instructions that can be read by the control and processing means 11 when the device 1 is in an operating condition;
a mass memory means 13, preferably one or more magnetic disks (hard disks) or a flash memory or other type, which is in signal communication with the control and processing means 11 and with the volatile memory means 12, and wherein said memory means 13 preferably stores lottery data which allow to determine the results of the wagers, i.e., whether a wager is winning or losing;
a communication means 14, preferably a network interface operating according to a standard of the family IEEE 803.2 (also known as Ethernet) or 802.11 (known as WiFi™) or 802.16 (known as WiMAX™) or an interface to a data network of the GSM™/GPRS™/UMTS™/LTE™ or TETRA™ or other type, which allows the device 1 to communicate with other devices through a network of data, where the latter will be better described later in this description;
an input/output (I/O) means 15 which can for example be used to connect peripherals (such as for example one or more interfaces which allow access to another mass memory means, such as flash or magnetic memories, in such a way as to allow preferably the copying of the information therefrom to the mass memory means 13) to said device 1 or to a programming terminal configured to write instructions (which the processing and control means 11 will have to execute) in the memory means 12,13; such input/output means 14 can for example comprise a USB™, IEEE 1394, RS232, IEEE 1284 or other adapter;
a communication bus 17 which allows the exchange of information between the control and processing means 11, the volatile memory means 12, the mass memory means 13, the communication means 14, and the input/output means 15.

As an alternative to the communication bus 17, it is possible to connect with a star architecture the control and processing means 11, the volatile memory means 12, the mass memory means 13, the communication means 14 and the input/output means 15.

It should be noted from the outset that the mass memory means 13 can also be replaced by remote mass memory means (for example a Storage Area Network—San) which are not included in said device 1; for this purpose, the input/output means (I/O) 15 can comprise one or more interfaces for access to mass memory such as for example FC (Fibre Channel) and/or iSCSI (Internet SCSI), so that the device 1 can be configured to access said remote mass memory means.

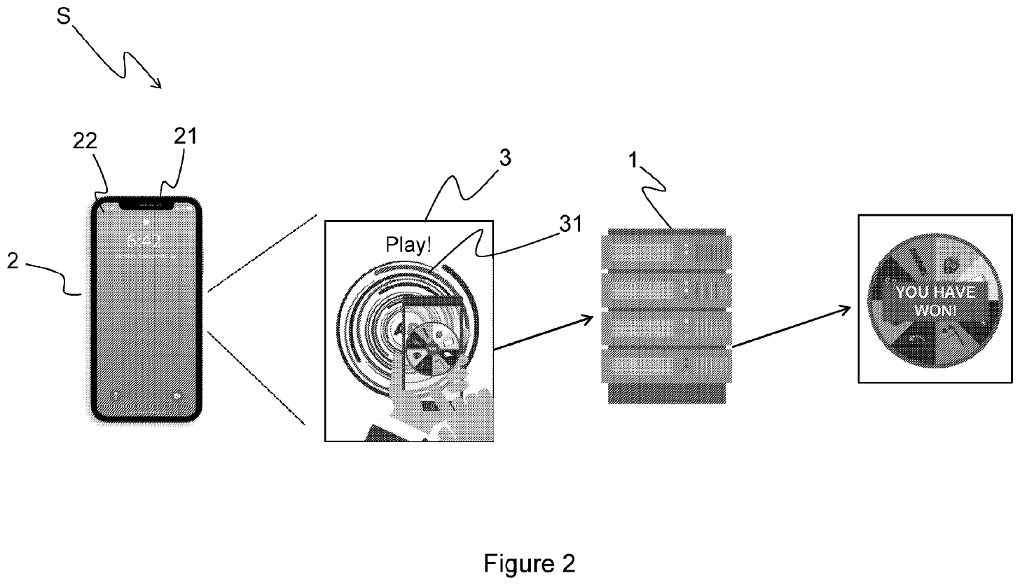

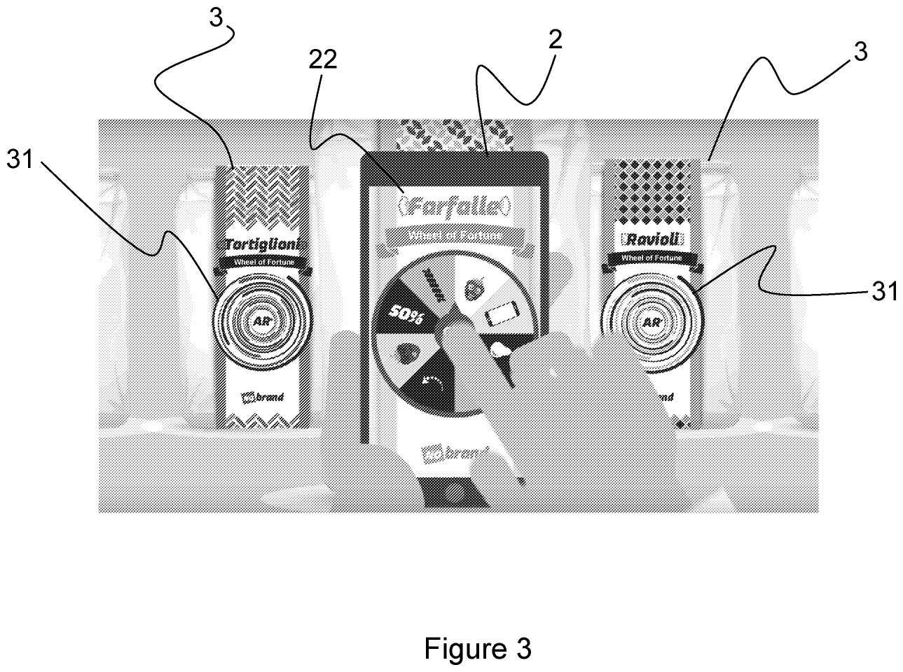

With reference also to FIGS. 2 and 3, a system S for verifying wagers in a lottery will now be described; said system S comprises the device 1 according to the invention and a user apparatus 2 (such as for example a smartphone, a tablet, a smartwatch or other) according to the invention.

The user apparatus 2 preferably comprises the following elements:
a communication means adapted to communicate with said device 1, such as for example an interface capable of communicating with a wireless telecommunications network, such as a GSM™, UMTS™, LTE™, 5G™, TETRA™ or other network;
an input means (such as, for example, an I/O controller in communication with a camera, a radio receiver of the Bluetooth™, RFID™ or other type) adapted to acquire an identification datum that identifies at least one wager, such as an alphanumeric string that identifies the player, the wager and/or the apparatus 2 (such as IMEI);
a positioning means (such as a GNSS receiver or other positioning system such as a WiFi™, Bluetooth™ based indoor positioning system, cellular network base stations or other) that may be configured to determine position data (such as for example a pair of decimal numbers with fixed precision) that describe a position in which the input means has acquired the identification datum, i.e., the position in which said at least one wager has been made;
a processing means (such as a CPU) configured to transmit, through said communication means, said identification datum and said position data to the device 1;
a display means 22 (such as for example a touch-sensitive display) that can display images generated by said processing means.

These steps can be implemented by a set of instructions that form an application, preferably downloadable over the Internet from an online service such as Apple® Store, Google® Play, or other.

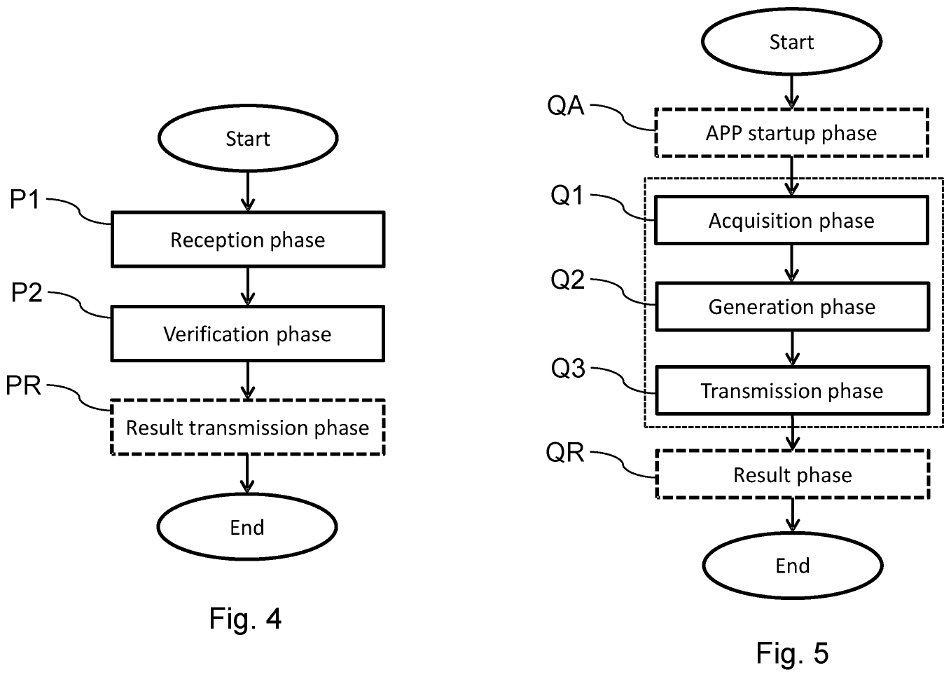

With reference also to FIGS. 4 and 5, the system S will now be described in an operating condition.

When the user apparatus 2 is in an operating condition, this user apparatus 2 executes a method for performing at least one wager in a lottery according to the invention. This method comprises the following steps:
a. an acquisition step Q1, in which, through an input means, an identification datum that identifies the wager is acquired;
b. a generation step Q2, wherein, through a processing means, product data are generated on the basis of said at least one image, where said product data define at least one property of the product or its package, such as for example a type of product, a brand 31 on the package 3 or on the product, a number identifying a batch of products or other;
c. a transmission step Q3, wherein, through a communication means, said identification datum and said product data are transmitted to the device 1 preferably in encrypted form.

It is pointed out that the generation step Q2 can be implemented using different techniques, such as for example by executing a set of instructions that encodes a neural network that has been specially trained to recognize a given product and/or a package of said product.

Before carrying out the steps of the method just described above, the user apparatus 2 is preferably configured to carry out a start-up step QA, in which the processing means, preferably following a command given by the user (for example by voice or by a pressure on the display means 22), starts the application that implements the method described above.

In addition to or as an alternative to the one just described above, the user apparatus 2 can be configured to perform, following the steps of the method described above, a result step QR, in which the wager results determined by the device 1 are presented as described below.

It is pointed out that the results of the wager can also be transmitted in another way (such as for example via electronic mail, ordinary mail or other), without however departing from the teachings of the present invention.

When the device 1 is in an operating condition, it executes a method for verifying at least one wager in a lottery according to the invention; this method comprises the following steps:
a. a reception step P1, wherein, through a communication means 14, at least one wager message is received, preferably in encrypted form, which comprises the identification datum that identifies the wager and the product data defining at least one property of the product or of its package;
b. a verification step P2, wherein, through a processing means 11, a result of said at least one wager (and possibly the outcome thereof is also determined) is verified on the basis of at least said identification datum and said product data, for example, by comparing said data with the lottery data.

In this way, it is possible to reduce the likelihood for a brute force attack on the instant lottery to be successful, thus increasing the level of security of said instant lottery.

Following the verification step P2, the device 1 preferably also performs a result transmission step PR, in which it transmits, preferably through the communication means, the result of said at least one wager to the apparatus 2 which, by carrying out the result step QR, submits it to the user.

As already described above, the results of the wager can also be transmitted in another way (such as, for example, by electronic mail, ordinary mail or other), without however departing from the teachings of the present invention.

In combination with or as an alternative to what has just been described, the wager message may also comprise position data that describe a position in which said at least one wager has been made, and where, during the verification step P2, the result of said at least one wager (and possibly the outcome is also determined) is verified also on the basis of said position data. As will be better explained below, this allows to increase the level of security of the instant lottery.

In combination with or as an alternative to the position data, the wager message may also comprise a time datum that describes when the wager was performed, and where, during the verification step P2, the result of said wager is determined also on the basis of said time datum. This increases the level of security of the instant lottery.

In an instant “treasure hunt” lottery where at least one product or package 3 is placed in a particular place (for example, amid the shelves of a shop, in a car park or in other public areas of a large shopping centre), the lottery data defines for each product involved in the lottery, the position in which the product is displayed. In this particular type of lottery, the time datum together with the identification datum allow to verify that the wager is the first to be performed for a certain coupon, while the position allows to verify that the wager was performed from a position close to the place where the product or its package was positioned.

In this way, it is possible to reduce the likelihood for an attack on the instant lottery to be successful, thus increasing the level of security of said instant lottery.

The time datum, which is received during the reception steps P1 and used during the verification step P2, can be generated by the user apparatus 2, by the device 1 upon the reception of the wager message, or by a second device which will be better described in the continuation of this description.

As an alternative or in combination with what has been described above, the user apparatus 2 may also comprise an image sensor 21 (also known as a ‘photocammer’) for acquiring images, wherein said image sensor 21 is in communication with the input means of said user apparatus 2. This enables acquiring images that contain product data encoded in graphic form, such as for example in the form of letterings, drawings 31, symbols or other. In order to do this, said image sensor and/or said processing means of said user apparatus 2 are configured to execute a set of instructions that encodes an image recognition algorithm, the execution of which allows to identify the product data encoded in graphic form in the images acquired by the image sensor 21 producing at least one output product datum. In other words, the processing means of the user apparatus 2 is also configured to perform (during the acquisition step Q1) the following steps:
acquiring, through said image sensor, at least one image representing an environment, preferably an environment surrounding said user apparatus 2,
extracting the product data from said at least one image, such as for example an alphanumeric string in which some of the product data are encoded, such as type, identifier, expiration, batch number or other.

In combination with or as an alternative to what has just been described, the user apparatus 2 can comprise a receiver or a radio transceiver (such as for example an RFID™, Bluetooth™ or other interface) for receiving radio signals which can contain wager identification data in encoded form, where said radio receiver is communication with the input means of said user apparatus 2. In other words, the processing means of the user apparatus 2 is also configured to
acquire, through the radio receiver (or transceiver), at least one radio signal;
decode said radio signal, extracting the identification datum that identifies the wager.

This allows to store wager codes in short-range radio transmitters or transceivers which, cyclically or on interrogation, transmit a radio signal containing at least one wager code. It is pointed out that an RFID™ transceiver can be advantageously integrated in a product or in its package, thus making it possible to perform the wager from any user apparatus 2 comprising an RFID™ transceiver.

This further allow to increase the level of security to the instant lottery, reducing the likelihood for an attack to be successful.

In the case where the user apparatus 2 comprises the image sensor 21, said user apparatus 2 can implement augmented reality functionality. In particular, the processing means can be configured to perform the following steps when the input means acquires said at least one image (acquisition step Q1):
generating a (virtual) image or film preferably on the basis of the images acquired during the acquisition step Q1;
displaying a video flow acquired by the image sensor 21 on the display means 22, superposing said (virtual) image or said film with said video flow.

This allows to produce, in addition to an attractive effect for the customer, also a use of the user apparatus (for example a smartphone) so that said user apparatus acquires further data (such as for example position data or data associated with the environment surrounding the product depicted in the acquired image), so that further controls of the performed wagers are possible and thus the level of security of the instant lottery is advantageously increased.

In greater detail, the use of augmented reality allows the user apparatus to acquire a second image depicting an environment surrounding the product or the package of said product, and to generate environmental data that describe the environment (such as for example the shelf on which the product is placed, the area surrounding said product or other) on the basis of said at least one second image, for example using photogrammetry algorithms or other. In other words, the wager message may also comprise environmental data that describe an environment in which the wager took place and wherein the processing means 11 of the device 1 is configured to determine the result of said at least one wager also on the basis of said environmental data. In this way, it is verified whether the wager took place in the place that has been designated and coded in the lottery data even without using the positioning means, thus increasing the level of security of the instant lottery.

Moreover, the use of augmented reality allows attracting the attention of the user who, stimulated to look at the display means 22, raises said user apparatus 2 till the height of his face. In this position, the positioning means can advantageously determine a position with greater accuracy. In fact, by capturing the attention of the user, it is possible to ensure that the latter keeps the device in a stable position (for a certain time) which allows said user to see what displayed by the display means 22; moreover, this position is advantageously away from the body, allowing to improve the level of power of the positioning signals received by the positioning means.

In this way, more precise position data are obtained, allowing to define criteria for acceptance of the wagers (i.e., of the lottery data) with a smaller tolerance in the position, so as to advantageously reduce the likelihood for an attack on the instant lottery to be successful and, therefore, increasing the level of security of the instant lottery.

In order to prevent the device 1 from becoming a target of a cyber attack (such as for example a Denial of service—DOS—attack), the system S may also comprise a filtering device (such as an application firewall) that comprises at least the following elements:
a processing means, such as for example one or more CPUs, which controls the operation of said filtering device, preferably in a programmable manner, by executing appropriate instructions;
a system clock able to keep track of the passing of time, and in communication with said processing means;
a communication means, preferably a network interface operating according to a standard of the family IEEE 803.2 (also known as Ethernet) or 802.11 (known as WiFi™) or 802.16 (known as WiMAX™) or an interface to a data network of the GSM™/GPRS™/UMTS™/LTE™ or TETRA™ or other type, which allows the filtering device to communicate, preferably through a data network, with the device 1 and with the user apparatus 2 according to the invention.

The processing means of the filtering device is configured to perform the following steps:
to receive, through the communication means, the identification datum and the product data transmitted by the user apparatus 2;
to generate, through said system clock, a time datum;
to generate a wager message comprising said identification datum, said product data and the time datum (just generated);
to transmit, through the communication means, the wager message to the device 1.

This allow the manipulation of time data by an attacker to be avoided. Moreover, it allows to reduce the load on the device 1 in case of cyber attack; in fact, the filtering device, in case it identifies the occurrence of a cyber attack, can advantageously slow down the execution of the above reported steps, preventing the availability of the resources of the device 1 (which has access to lottery data, such as winning wager codes) from being reduced to such an extent as to compromise computer security, for example by blocking the portion of operating system that manages the control of the accesses to the filesystem. In this way, it is possible to reduce the likelihood for an attack on the instant lottery to be successful, thus increasing the level of computer security of said instant lottery.

Some of the possible variants have been described above, but it is clear to the person skilled in the art that, in the practical embodiment, other embodiments also exist, with different elements that can be replaced by other technically equivalent ones. The present invention is therefore not limited to the illustrative examples described, but is susceptible to various modifications, improvements, replacements of parts and equivalent elements without causing deviations from the basic inventive idea, as specified in the following claims.

1. A method for verifying at least one wager in a lottery, comprising:
a. a reception phase, wherein, through a communication means, at least one wager message is received which comprises an identification datum that allows to identify said at least one wager, and
b. a verification phase, wherein, through a processing means, said at least one wager is verified on the basis of at least said identification datum, wherein
said wager message also comprises product data that can be generated on the basis of at least one image depicting at least one portion of a product or of a package of said product and that define at least one property of said product or said package, and where, during the verification phase, said at least one wager is also verified on the basis of said product data.

2. The method according to claim 1, wherein said at least one wager message also comprises position data that describe a position in which said at least one wager has been performed and where, during the verification phase, the result of said at least one wager is also verified on the basis of said position data.

3. The method according to claim 1, wherein said at least one wager message also comprises environmental data that describe an environment in which the wager took place and where, during the verification phase, the result of said at least one wager is also verified on the basis of said environmental data.

4. The method according to claim 1, wherein said at least one wager message also comprises a time datum that describes when said at least one wager was performed, and where, during the verification phase, said at least one wager is also verified on the basis of said time datum.

5. A device for verifying at least one wager in a lottery, comprising:
a communication means adapted to receive at least one wager message that comprises an identification datum that allows to identify said at least one wager, and
a processing means configured to verify said at least one wager on the basis of at least said identification datum, wherein
the wager message also comprises product data that can be generated on the basis of at least one image depicting at least one portion of a product or of a package of said product and that define at least one property of said product or said package, and wherein said processing means is configured to verify said at least one wager also on the basis of said product data.

6. The device according to claim 5, wherein the wager message also comprises position data that describe a position in which said at least one wager has been performed, and wherein said processing means is configured to verify said at least one wager also on the basis of said position data.

7. The device according to claim 5, wherein the wager message also comprises environmental data that describe an environment in which the wager took place, and where said processing means is configured to verify said at least one wager also on the basis of said environmental data.

8. The device according to claim 5, wherein said at least one wager message also comprises a time datum that describes when said at least one wager was performed, and where the processing means is configured to verify said at least one wager also on the basis of said time datum.

9. A method for performing at least one wager in a lottery with a device according to claim 5, comprising:
a. an acquisition phase in which, through an input means, an identification datum that allows to identify said at least one wager is acquired,
wherein
during said acquisition phase, through said input data, at least one image depicting at least a portion of a product or of a package of said product is also acquired, and wherein said method also comprises
b. a generation phase, wherein, through a processing means, product data are generated on the basis of said at least one image, where said product data define at least one property of said product or said package,
c. a transmission phase, wherein, through a communication means, said identification datum and said product data are transmitted to the device.

10. The method according to claim 9, wherein, during the acquisition phase, in which, through said input means, position data describing at least one position in which said at least one wager was performed are also acquired, and wherein, during the transmission phase said position data are also transmitted to the device.

11. The method according to claim 9, wherein, during the acquisition phase, an image or a film is generated through the processing means, and a video flow acquired by an image sensor is displayed, through a display means, superposing said image or said film with said video flow.

12. The method according to claim 11, wherein, during the acquisition phase, at least a second image is acquired which depicts an environment surrounding the product or the package of said product, wherein, during the generation phase, environmental data describing said environment are generated on the basis of said at least one second image, and wherein, during the transmission phase, said environmental data are transmitted to the device.

13. A computer program product loadable into the memory of a computer and comprising a portion of software code for implementing the phases of the method according to claim 9.

14. A user apparatus for performing at least one wager in a lottery with a device according to claim 5, comprising:
a communication means adapted to communicate with said device,
an input means adapted to acquire an identification datum that allows to identify said at least one wager,
further comprising:
a processing means configured to:
a. acquire, through said input means, also at least one image depicting at least one portion of a product or of a package of said product,
b. generate product data on the basis of said at least one image,
c. transmit, through said communication means, said identification datum and said product data to the device.

15. The user apparatus according to claim 14, comprising a positioning means configured to determine position data that describe at least one position in which the input means has acquired said at least one image, and wherein said processing means is also configured to transmit, through said communication means, said position data to the device.

16. The user apparatus according to claim 14, comprising a display means that can display images generated by said processing means, wherein the processing means is also configured to
generate an image or a film,
display, through the display means, a video flow acquired by an image sensor, superposing said image or said film with said video flow,
when the input means acquires said at least one image.

17. The user apparatus according to claim 16, wherein the processing means is also configured to
acquire, through the input means, at least a second image that depicts an environment surrounding the product or the package of said product,
generate environmental data that describe said environment on the basis of said at least one second image, and
transmit, through said communication means, said environmental data to the device.

18. A system S for verifying wagers in a lottery, comprising a user apparatus according to claim 14, a device for verifying at least one wager in a lottery, and a filtering device that comprises:
a system clock adapted to keep track of the passing of time,
a second communication means in communication with the device and with the user apparatus,
a processing means configured to
a. receive, through the second communication means, the identification datum and the product data transmitted by the user apparatus,
b. generate, through said system clock, the time datum,
c. generate the wager message comprising said identification datum, said product data and the time datum,
d. transmit, through the communication means, said wager message to the device.
